(19) United States
(12) Patent Application Publication
(10) Pub. No.: US 2020/0070666 A1
(43) Pub. Date: Mar. 5, 2020

(54) Vehicle Alignment System

(71) Applicant: Ford Global Technologies, LLC, Dearborn, MI (US)

(72) Inventors: Venkateswara Anand Sankaran, Farmington Hills, MI (US); John Paul Gibeau, Canton, MI (US); Christopher W. Bell, Livonia, MI (US)

(73) Assignee: Ford Global Technologies, LLC, Dearborn, MI (US)

(21) Appl. No.: 16/114,370

(22) Filed: Aug. 28, 2018

(51) Int. Cl. B60L 11/18; B62D 15/02; B60T 7/12; B60T 8/172

(52) U.S. Cl. CPC B60L 11/1833; B60L 11/1831; B62D 15/0285; B60T 8/17555; B60T 8/172; B60T 2201/10; B60T 7/12

(57) ABSTRACT

A vehicle including a primary coil, a secondary coil, and a controller is provided. The controller may be programmed to position the secondary coil relative to a primary coil by, responsive to increases in voltage induced in the secondary coil by the primary coil, commanding the vehicle forward. The controller may be further programmed to, responsive to decreases in the voltage immediately following increases, commanding the vehicle forward a predetermined distance. The controller may be further programmed to, responsive to decreases in the voltage immediately beyond the predetermined distance, command the vehicle reverse. The controller may be further programmed to position the secondary coil relative to the primary coil by, responsive to increases in the voltage during reverse movement of the vehicle, command the vehicle reverse.

### TECHNICAL FIELD

The present disclosure relates to a vehicle control strategy for positioning a vehicle in a predetermined charge location adjacent a charge station.

### BACKGROUND

Under certain vehicle charge scenarios, such as parking a vehicle over a wireless charge pad, available methods and systems may require driver inputs and maneuvers to position the vehicle relative to the charge pad to facilitate a charge operation. These driver inputs and maneuvers may lead to positioning the vehicle in a location that does not maximize charge efficiency.

### SUMMARY

A vehicle includes a primary coil, a secondary coil, and a controller. The controller is programmed to position the secondary coil relative to a primary coil by, responsive to increases in voltage induced in the secondary coil by the primary coil, commanding the vehicle forward. The controller is further programmed to, responsive to decreases in the voltage immediately following increases, commanding the vehicle forward a predetermined distance. The controller is further programmed to, responsive to decreases in the voltage immediately beyond the predetermined distance, commanding the vehicle reverse. The controller may be further programmed to position the secondary coil relative to the primary coil by, responsive to increases in the voltage during reverse movement of the vehicle, commanding the vehicle reverse. The controller may be further programmed to position the secondary coil relative to the primary coil by, responsive to decreases in the voltage during reverse movement of the vehicle immediately following increases, commanding the vehicle stop. The vehicle may further include a vehicle sensor system to identify obstacles in a travel path. The controller may be further programmed to output manual steering instructions to a cabin interface to move the vehicle to a charge region adjacent the primary coil based on a travel path identified by the vehicle sensor system. The vehicle may further include a vehicle steering module and the controller may be further programmed to output steering instructions to the vehicle steering module to move the vehicle to a charge region adjacent the primary coil based on a travel path identified by the vehicle sensor system. The controller may be further programmed to output a stop command to the vehicle responsive to detection by the sensor system of an obstacle in the travel path to a charge region adjacent the primary coil.

A method for a vehicle includes, by a controller, positioning a secondary coil of the vehicle relative to a primary coil by, responsive to increases in voltage induced in the secondary coil by the primary coil, commanding the vehicle forward. The method further includes, responsive to decreases in the voltage immediately following increases, commanding the vehicle forward a predetermined period of time. The method further includes, responsive to decreases in the voltage immediately after the period of time, commanding the vehicle reverse. The controller may be further programmed to position the secondary coil relative to the primary coil by, responsive to increases in the voltage during reverse movement of the vehicle, commanding the vehicle reverse. The controller may be programmed to position the secondary coil relative to the primary coil by, responsive to decreases in the voltage during reverse movement of the vehicle immediately following increases, commanding the vehicle stop. The method may further include identifying obstacles in a travel path, and outputting manual steering instructions to a cabin interface to move the vehicle to a charge region adjacent the primary coil based on a travel path. The method may further include outputting a stop command responsive to detection of an obstacle in the travel path to a charge region adjacent the primary coil.

A vehicle alignment system includes a vehicle cabin interface, a charge receive coil, and a controller. The controller is in communication with the vehicle cabin interface and the charge receive coil and is programmed to output steering instructions to the vehicle cabin interface to direct a driver to position the vehicle in a charge region located adjacent a charge station based on an amount of charge output received by the charge receive coil from a charge transmit coil of the charge station. The system may further include a steering module and one or more sensors. The steering module and the one or more sensors may be in communication with the controller. The one or more sensors may be oriented upon the vehicle to identify a travel path from a current vehicle position to the charge region. The controller may be further programmed to output steering instructions to the steering module based on the identified travel path to direct movement of the vehicle to the charge region without or with minimal driver input. Each of the one or more sensors may be oriented upon the vehicle to identify a travel path from a current vehicle position to the charge region and each of the one or more sensors may be oriented upon the vehicle to detect an obstacle located within the travel path. The controller may be further programmed to output a stop command to a brake system responsive to detection by the one or more sensors of an obstacle located within the travel path. The one or more sensors may be one of a radio frequency sensor, an ultrasonic sensor, or an infrared sensor. The controller may be further programmed to access an energy graph to identify a travel path distance associated with the amount of charge output received by the charge receive coil. The travel path distance may be reflective of a distance between the charge receive coil located at the current vehicle position and the charge region located adjacent the charge station. The system may further include a parking brake system and the controller may be further programmed to activate the parking brake system responsive to detection of the vehicle stopping in the charge region.

### BRIEF DESCRIPTION OF THE DRAWINGS

FIG. 1 is a schematic diagram illustrating an example of an electrified vehicle.

FIG. 2 is a schematic diagram illustrating an example of an electrified vehicle and a vehicle charge station.

FIG. 3 is a graph illustrating an example of a charge receive unit and a charge transmit unit relationship based on spacing.

FIG. 4 is a flow chart illustrating an example of a control strategy for charging an electrified vehicle.

### DETAILED DESCRIPTION

Embodiments of the present disclosure are described herein. It is to be understood, however, that the disclosed embodiments are merely examples and other embodiments may take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the present disclosure. As those of ordinary skill in the art will understand, various features illustrated and described with reference to any one of the figures may be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be used in particular applications or implementations.

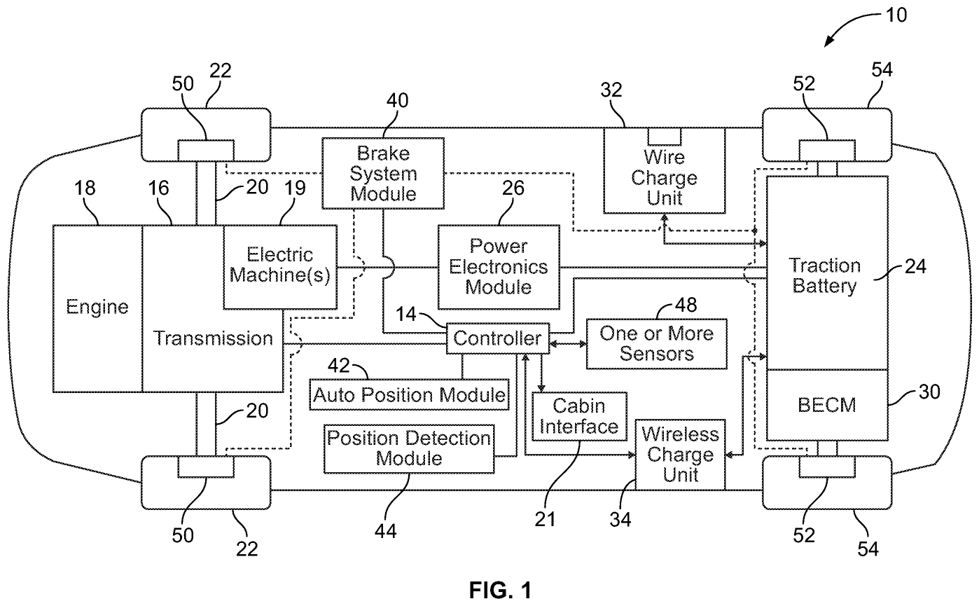

FIG. 1 is a schematic diagram illustrating an example of a vehicle, referred to generally as a vehicle 10 herein. The vehicle 10 may include a controller 14 to direct operation of vehicle 10 components. For example, the controller 14 may be in communication with a transmission 16 mechanically connected to an engine 18 and one or more electric machines 19. A cabin interface 21 may be in communication with the controller 14 to receive information relating to conditions of the vehicle 10 components. The cabin interface 21 may output notifications, such as visual outputs and audio outputs, to passengers of the vehicle 10 reflective of the information relating to conditions of the vehicle components. In one example, the cabin interface 21 may be a touchscreen display.

Each of the one or more electric machines 19 may be capable of operating as a motor or a generator. When operating as a motor, each of the one or more electric machines 19 may provide propulsion and deceleration capability when the engine 18 is turned on or off. When operating as a generator, each of the one or more electric machines 19 may provide fuel economy benefits by recovering energy that would normally be lost as heat in a friction braking system.

The transmission 16 is also mechanically connected to a drive shaft 20 coupled to rear wheels 22. The engine 18 may provide propulsion to the rear wheels 22 via the transmission 16 and the drive shaft 20. The engine 18 and the one or more electric machines 19 may be part of a vehicle propulsion system. Additionally, a traction battery may also be part of the propulsion system to provide power for additional propulsion and vehicle component operation.

For example, a traction battery 24 may store energy for use by the one or more electric machines 19. The traction battery 24 may include one or more high voltage batteries and may provide a high voltage DC output from one or more battery cell arrays, sometimes referred to as battery cell stacks, within the traction battery 24. Each of the battery cell arrays may include one or more battery cells. The traction battery 24 is electrically connected to one or more power electronics modules 26. The power electronics module 26 may also be electrically connected to the one or more electric machines 19 and may provide the ability to bi-directionally transfer electrical energy between the traction battery 24 and the one or more electric machines 19.

For example, the traction battery 24 may provide a DC voltage while the one or more electric machines 19 may require a three-phase AC voltage to function. The power electronics module 26 may convert the DC voltage to a three-phase AC voltage as required by the one or more electric machines 19. In a regenerative mode, the power electronics module 26 may convert the three-phase AC voltage from the one or more electric machines 19 acting as generators to the DC voltage required by the traction battery 24.

In addition to providing energy for propulsion, the traction battery 24 may provide energy for other vehicle electrical systems. The vehicle electrical systems may include a DC/DC converter module that converts the high voltage DC output of the traction battery 24 to a low voltage DC supply that is compatible with other vehicle loads. Other high-voltage loads, such as compressors and electric heaters, may be connected directly to the high-voltage without the use of the DC/DC converter module. In a typical vehicle, the low-voltage systems are electrically connected to an auxiliary battery (e.g., a twelve-volt battery).

A battery electrical control module (BECM) 30 may be in communication with the traction battery 24. The BECM 30 may operate as a controller for the traction battery 24 and may also include an electronic monitoring system that manages temperature and charge state of each battery cell of the traction battery 24. The traction battery 24 may have a temperature sensor such as a thermistor or other temperature gauge. The temperature sensor may be in communication with the BECM 33 to provide temperature data regarding the traction battery 24.

The traction battery 24 may be recharged by an external power source such as an electrical outlet or a wireless charge pad. For example, a wire charge unit 32 may include components to facilitate wired connection to an external power source outlet. The wire charge unit 32 may include a charge port for receiving a charge connector of the external power source. The wire charge unit 32 may facilitate energy transfer from the external power source to the traction battery 24 to replenish a charge of the traction battery 24.

As another example, a wireless charge unit 34 may include components to facilitate wireless connection to an external power source. The wireless charge unit 34 may assist in facilitating energy transfer from the external power source to the traction battery 24 to replenish a charge of the traction battery 24. One example of the wireless charge unit 34 may include a charge receive coil to receive energy from a charge pad as further described herein. The wire charge unit 32 or the wireless charge unit 34 may include circuitry and controls to regulate and manage the transfer of electrical energy between the external power source and the traction battery 24.

Components of the vehicle 10 may operate with one another as an alignment system to position the vehicle at an identified target or region. For example, the vehicle 10 may include a brake system module 40, an auto position module 42, and a position detection module 44, each in electrical communication with the controller 14. One or more sensors 48 may be in electrical communication with the vehicle 10 components such as the controller 14, the brake system module 40, the auto position module 42, and the position detection module 44. While the one or more sensors 48 are represented as a square in the vehicle 10 schematic diagram of FIG. 1, it is contemplated that one or more sensors 48 may be located at various locations of the vehicle 10 to provide detected information to the controller 14. Examples of the one or more sensors 48 may include radio frequency (RF) sensors, ultrasonic sensors, infrared sensors, a camera, a laser, or other similar sensors. The one or more sensors 48 may be located at outer portions of the vehicle 10 to detect conditions, objects, and obstacles external to the vehicle 10. The one or more sensors 48 may operate to assist in positioning the vehicle 10 at a predetermined location with minimal or without driver input as further described herein. For example, the one or more sensors 48 may operate to identify a travel path for the vehicle 10 to move to a location, such as a charge region.

The brake system module 40 may be in communication with a brake unit 50 of each of the rear wheels 22 and a brake unit 52 of each of a set of front wheels 54 to reduce and/or cease rotation of a respective wheel to slow or stop movement of the vehicle 10. Examples of the brake unit 50 and the brake unit 52 include an anti-lock brake unit or other brake unit that utilizes pressurized air to reduce and/or cease rotation of a wheel. The brake system module 40 may also include a parking brake system for selective application when the vehicle 10 is stopped. The controller 14 may include programming to activate the parking brake system when, for example, the vehicle 10 is stopped and receiving a charge from a charge station.

The auto position module 42 may assist in positioning the vehicle 10 in a predetermined position without driver input or with minimal driver input. The auto position module 42 may operate with the one or more sensors 48, the controller 14, a propulsion system such as the engine 18 or the traction battery 24, and the brake system module 40 to direct vehicle 10 movement to a predetermined location. The position detection module 44 may operate with the one or more sensors 48 to identify a position of the vehicle 10 relative to an identified target or identified region.

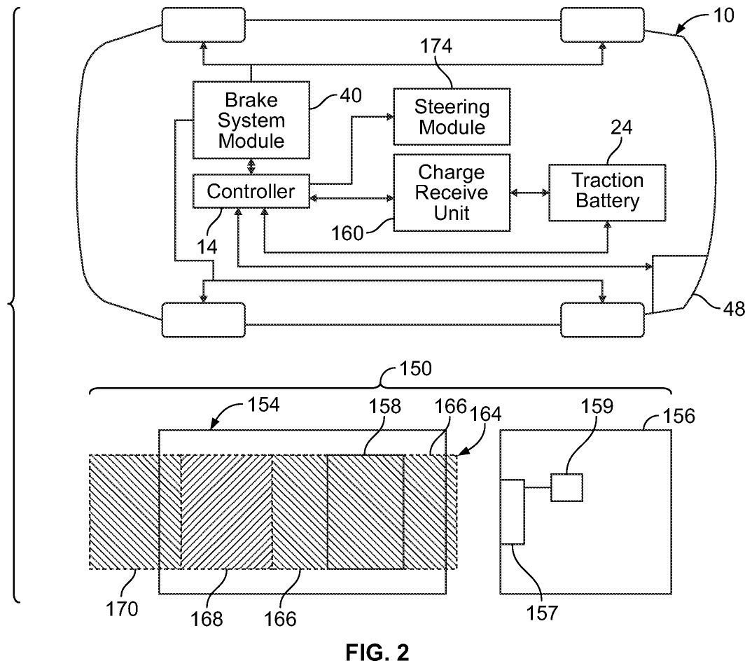

FIG. 2 is a schematic diagram illustrating an example of the vehicle 10 and a vehicle charge station 150. The vehicle charge station 150 may include a charge pad 154 and a station housing 156. The station housing 156 may include an electrical connection assembly 157 in electrical communication with a station controller 159. The charge pad 154 may include a charge transmit unit 158. The charge transmit unit 158 may include electrical components to receive signals from the station controller 159. The station controller 159 may include programming to direct operation of the charge transmit unit 158 based on a detected location of a vehicle. The charge transmit unit 158 may include components to facilitate a wireless transfer of energy. In one example, the charge transmit unit 158 includes a charge transmit coil to output a charge for receipt by a charge receive coil to wirelessly transfer energy to a vehicle for recharging a vehicle high voltage battery. The charge coil may also be referred to as a primary coil herein. For example, the wireless charge unit 34 of the vehicle 10 described above may include components, such as a charge receive unit 160, to receive energy from an external source.

The charge receive unit 160 may include components to facilitate a wireless receipt of energy. In one example, the charge receive unit 160 includes a charge receive coil to receive a charge output from a charge transmit coil to wirelessly receive energy from an external source, such as the charge transmit unit 158, for charging the traction battery 24. The charge receive coil may be referred to as a secondary coil herein. The station controller 159 may include programming to direct operation of components of the vehicle charge station 150 and may include components to communicate with a vehicle, such as the vehicle 10, to facilitate transferring a charge from the vehicle charge station 150 to the vehicle 10.

The controller 14 may also include programming to interface with the charge station 150 to facilitate positioning the vehicle 10 in a predetermined location 164 to receive the charge outputs from the charge station 150. The predetermined location 164 may include a plurality of regions, each region reflective of an amount of charge output the charge transmit unit 158 may output based on a distance between the charge transmit unit 158 and the charge receive unit 160. In one example, the predetermined location 164 may include a first region 166, a second region 168, and a third region 170. Charge information relating to the predetermined location 164 may be stored and accessible by the controller 14.

The first region 166 may be located directly adjacent the charge transmit unit 158 and may represent the largest amount of charge output potential in comparison to the other two regions. An area of the first region 166 may be based on vehicle components and charge station components. When the charge receive unit 160 is located within the first region 166, the charge transmit unit 158 may output a charge of approximately 3.3 kW.

An area of the second region 168 may also be based on vehicle components and charge station components. When the charge receive unit 160 is located within the second region 168, the charge transmit unit 158 may output a charge of approximately 2.5 kW. An area of the third region 170 may also be based on vehicle components and charge station components. When the charge receive unit 160 is located within the third region 170, the charge transmit unit 158 may output a charge of approximately 2.0 kW.

The charge receive unit 160 or the controller 14 may include programming to identify vehicle 10 positioning relative to the plurality of regions of the predetermined location 164 based on the amount of detected charge output from the charge transmit unit 158. For example, if the charge receive unit 160 detects an amount of charge output from the charge transmit unit 158, the charge receive unit 160 may send a signal including the detected charge amount to the controller 14 and the controller 14 may identify vehicle 10 location relative to the first region 166, the second region 168, or the third region 170.

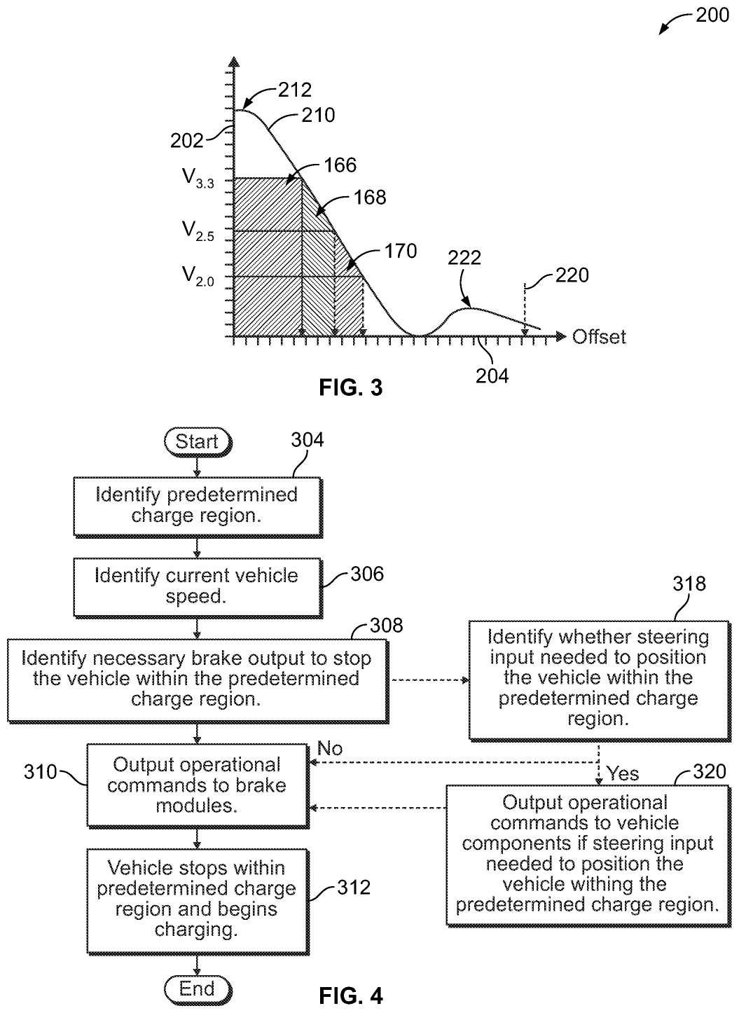

FIG. 3 is a graph illustrating an example of charge characteristics based on a location of a vehicle charge receive unit relative to a charge transmit unit, referred to generally as a graph 200. The graph 200 may illustrate a charge relationship between or charge characteristics of the charge receive unit 160 and the charge transmit unit 158. A Y-axis 202 may represent an output charge from a charge transmit unit of a charge station, such as the charge transmit unit 158. An X-axis 204 may represent a position offset between a charge transmit unit and a charge receive unit, such as the charge transmit unit 158 and the charge receive unit 160 described above.

Plot 210 represents a feedback signal from a system that is based on charge output signal strength to locate the vehicle. Three regions are identified on the graph 200 representing the first region 166, the second region 168, and the third region 170. Line 220 represents a minimum amount of charge output detectable by the charge receive unit 160. If the charge receive unit 160 is spaced from the charge transmit unit 158 a distance greater than a predetermined threshold, the charge receive unit 160 will not detect any charge output from the charge transmit unit 158. The predetermined threshold may vary based on vehicle components and charge station components. In one example, the predetermined threshold may be approximately equal to one foot. If the charge receive unit 160 is spaced from the charge transmit unit 158 a distance identified between the third region 170 and the line 220, the charge receive unit 160 may detect a presence of charge output from the charge transmit unit 158 but will not be close enough to receive the charge output.

As shown on the graph, charge output from the charge transmit unit 158 increases as the charge receive unit 160 nears the charge transmit unit 158. A peak of charge transfer on the plot 210 may be referred to as a charge peak 212. As also shown on the graph, charge output from the charge transmit unit 158 increases near line 220 and then decreases prior to charge output increases associated with the first region 166, the second region 168, and the third region 170. This charge output increase followed by a charge output decrease may be due to a geometry of coils of the charge transmit unit 158 and the charge receive unit 160. A portion of plot 210 corresponding to this increase than decrease may be referred to as a charge bump 222. The controller 14 may receive one or more signals from the charge receive unit 160 indicating detected charge output from the charge transmit unit 158 and calculate vehicle 10 positioning relative to the plurality of regions.

The controller 14 may further include programming to direct movement of the vehicle 10 to a position within one of the plurality of regions. For example, the controller 14 may send commands to the brake system module 40 and/or a steering module 174 based on the detected charge amount received from the charge receive unit 160. In one example, the controller 14 may output commands to the brake system module 40 reflective of an amount of brake pressure needed to stop movement of the vehicle within one of the plurality of regions.

In another example, the controller may output steering commands to the steering module 174 to move the vehicle 10 to one of the plurality of regions and the steering module 174 may then operate to send commands to selective vehicle 10 components to move the vehicle 10 to one of the plurality of regions for charging. The steering commands may be executed automatically by the vehicle 10 components or the steering commands may be displayed upon the cabin interface 21 in a series of one or more steps to direct a driver to one of the plurality of regions for charging. For example, the auto position module 42 may be in communication with the controller and appropriate vehicle 10 components to move the vehicle 10 to an identified region based on signals received from the one or more sensors 48. The position detection module 44 may also be in communication with the controller and the one or more sensors 48 to identify a location of the vehicle 10 relative to the identified region.

In another example, the controller may be programmed to output propulsion system operation commands based on the graph 200 and amounts of charge output from the charge transmit unit 158 detected by the charge receive unit 160. The controller may be programmed to output a forward command to the propulsion system responsive to detection by the charge receive unit 160 of an increase in charge output by the charge transmit unit 158. In this example, the charge receive unit 160 may be approaching the first region 166, the second region 168, and the third region 170 on plot 210.

Subsequently, the controller may be programmed to output a forward command to the propulsion system responsive to the charge receive unit 160 detecting a decrease in charge output by the charge transmit unit 158 for a predetermined distance. In this example, the controller programming may compensate for the charge bump 222 by continuing to direct forward movement of the vehicle toward the regions in the event the vehicle detects a charge increase then a charge decrease. In the event the charge receive unit 160 does not detect an increase in charge output by the charge transmit unit 158 during movement of the vehicle along the predetermined distance, the controller may be programmed to output a reverse command to the propulsion system as the vehicle has likely traveled past the charge peak 212.

FIG. 4 is a flow chart illustrating an example of a control strategy for a vehicle alignment system to position a vehicle for receiving a charge from a charge station, referred to generally as a control strategy 300. In operation 304, a predetermined charge region, such as the first region 166, the second region 168, or the third region 170, is identified. The predetermined charge region may be a location for parking a vehicle, such as the vehicle 10, to receive a charge output from a charge transmit unit, such as the charge transmit unit 158 of the charge station 150. A controller, such as the controller 14, may include programming to interact with vehicle components and charge station components to identify a location of the predetermined charge region as described above. The controller may also access an energy graph to identify a travel path distance associated with an amount of charge station charge output detected by the charge receive unit. In one example, the charge station charge output may be output by a transmit coil. The travel path distance may be reflective of a distance between the charge receive unit located at the current vehicle position and the identified charge region located adjacent the charge station.

In another example, sensors, such as the one or more sensors 48, of the vehicle may operate to identify a travel path between a current vehicle position and the identified charge region. The sensors may further operate to detect an obstacle within the travel path and send signals to the controller to active a brake system, such as the brake system module 40, to stop the vehicle prior to contacting the detected obstacle. Additionally, a charge receive unit, such as the charge receive unit 160, may operate to detect a presence of charge output from a charge transmit unit, such as the charge transmit unit 158. The charge transmit unit may send signals to the controller identifying an amount of charge output detected and the controller may identify a vehicle position relative to the identified charge region based on the charge output detected. In operation 306, the controller may identify a current vehicle speed for use in calculating outputs to the brake system to position the vehicle within the identified charge region.

In operation 308, the controller may identify a necessary amount of brake output required to stop the vehicle within the identified charge region. For example, the controller may calculate an amount of brake pressure needed by wheel brake units, such as the brake units 50 and 52, and direct the brake system to output commands reflecting the calculated amount of brake pressure based on the identified current vehicle speed and the identified charge region in operation 310. As such, the controller may direct the vehicle to stop within the identified charge region to begin vehicle charge operations in operation 312. Optionally, the controller may be programmed to detect the vehicle's position within the identified charge region and activate a parking brake system, such as the parking brake system of the brake system module 40.

Optionally, the controller may identify whether one or more steering inputs is needed to position the vehicle within the identified charge region in operation 318. If the controller identifies that steering input is needed in operation 318, the controller may then output operation commands to vehicle components, such as the steering module 174, to steer the vehicle to the predetermined charge location in operation 320. In another example, the controller may output visual commands to a display of a cabin interface, such as the cabin interface 21, to instruct a driver on steering inputs needed to move the vehicle to the identified charge region.

The words used in the specification are words of description rather than limitation, and it is understood that various changes may be made without departing from the spirit and scope of the disclosure. As previously described, the features of various embodiments may be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics may be compromised to achieve desired overall system attributes, which depend on the specific application and implementation. These attributes may include, but are not limited to cost, strength, durability, life cycle cost, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and may be desirable for particular applications.

What is claimed is:

1. A vehicle comprising:
a secondary coil; and
a controller programmed to position the secondary coil relative to a primary coil by,
responsive to increases in voltage induced in the secondary coil by the primary coil, commanding the vehicle forward,
responsive to decreases in the voltage immediately following increases, commanding the vehicle forward a predetermined distance, and
responsive to decreases in the voltage immediately beyond the predetermined distance, commanding the vehicle reverse.

2. The vehicle of claim 1, wherein the controller is further programmed to position the secondary coil relative to the primary coil by, responsive to increases in the voltage during reverse movement of the vehicle, commanding the vehicle reverse.

3. The vehicle of claim 2, wherein the controller is further programmed to position the secondary coil relative to the primary coil by, responsive to decreases in the voltage during reverse movement of the vehicle immediately following increases, commanding the vehicle stop.

4. The vehicle of claim 1, further comprising a vehicle sensor system to identify obstacles in a travel path, wherein the controller is further programmed to output manual steering instructions to a cabin interface to move the vehicle to a charge region adjacent the primary coil based on a travel path identified by the vehicle sensor system.

5. The vehicle of claim 1, further comprising a vehicle steering module and a vehicle sensor system to identify obstacles in a vehicle travel path, wherein the controller is further programmed to output steering instructions to the vehicle steering module to move the vehicle to a charge region adjacent the primary coil based on a travel path identified by the vehicle sensor system.

6. The vehicle of claim 1, further comprising a sensor system to identify obstacles in a vehicle travel path, and wherein the controller is further programmed to output a stop command to the vehicle responsive to detection by the sensor system of an obstacle in a travel path to a charge region adjacent the primary coil.

7. A method for a vehicle comprising:
by a controller, positioning a secondary coil of the vehicle relative to a primary coil by,
responsive to increases in voltage induced in the secondary coil by the primary coil, commanding the vehicle forward,
responsive to decreases in the voltage immediately following increases, commanding the vehicle forward a predetermined period of time, and
responsive to decreases in the voltage immediately after the period of time, commanding the vehicle reverse.

8. The method of claim 7, wherein the controller is further programmed to position the secondary coil relative to the primary coil by, responsive to increases in the voltage during reverse movement of the vehicle, commanding the vehicle reverse.

9. The method of claim 8, wherein the controller is further programmed to position the secondary coil relative to the primary coil by, responsive to decreases in the voltage during reverse movement of the vehicle immediately following increases, commanding the vehicle stop.

10. The method of claim 7, further comprising identifying obstacles in a travel path, and outputting manual steering instructions to a cabin interface to move the vehicle to a charge region adjacent the primary coil based on a travel path.

11. The method of claim 7, identifying obstacles in a vehicle travel path, and outputting a stop command responsive to detection of an obstacle in a travel path to a charge region adjacent the primary coil.

12. A vehicle alignment system comprising:
a vehicle cabin interface;
a charge receive coil; and
a controller in communication with the vehicle cabin interface and the charge receive coil and programmed to output steering instructions to the vehicle cabin interface to direct a driver to position the vehicle in a charge region located adjacent a charge station based on an amount of charge output received by the charge receive coil from a charge transmit coil of the charge station.

13. The system of claim 12 further comprising:
a steering module in communication with the controller; and
one or more sensors in communication with the controller and oriented upon the vehicle to identify a travel path from a current vehicle position to the charge region,
wherein the controller is further programmed to output steering instructions to the steering module based on the identified travel path to direct movement of the vehicle to the charge region without or with minimal driver input.

14. The system of claim 12 further comprising one or more sensors in communication with the controller, wherein each of the one or more sensors is oriented upon the vehicle to identify a travel path from a current vehicle position to the charge region, and wherein each of the one or more sensors is oriented upon the vehicle to detect an obstacle located within the travel path.

15. The system of claim 14, wherein the controller is further programmed to output a stop command to a brake system responsive to detection by the one or more sensors of an obstacle located within the travel path.

16. The system of claim 15, wherein the one or more sensors includes one of a radio frequency sensor, an ultrasonic sensor, or an infrared sensor.

17. The system of claim 15, wherein the controller is further programmed to access an energy graph to identify a travel path distance associated with the amount of charge output received by the charge receive coil, and wherein the travel path distance is reflective of a distance between the charge receive coil located at the current vehicle position and the charge region located adjacent the charge station.

18. The system of claim 12 further comprising a parking brake system, wherein the controller is further programmed to activate the parking brake system responsive to detection of the vehicle stopping in the charge region.
